(19) United States
(12) Patent Application Publication
(10) Pub. No.: US 2015/0324969 A1
(43) Pub. Date: Nov. 12, 2015

(54) SYSTEM AND METHOD FOR MICROORGANISM EFFECTIVENESS ANALYSIS USING PARTICLE IMAGING

(71) Applicant: FLUID IMAGING TECHNOLOGIES, INC., Scarborough, ME (US)

(72) Inventors: Camilo A. DenBrok, Suwanee, GA (US); William P. Nolan, Martinez, GA (US)

(73) Assignee: FLUID IMAGING TECHNOLOGIES, INC., Scarborough, ME (US)

(21) Appl. No.: 14/274,180

(22) Filed: May 9, 2014

(51) Int. Cl. G06T 7/00; G06K 9/62; G02B 21/36

(52) U.S. Cl. CPC G06T 7/0004; G02B 21/365; G06K 9/6201; G06K 9/6267

(57) ABSTRACT

A system and method for determining the effectiveness of an anaerobic digestion process. The system includes a particle imaging system capable of capturing images of particles, including anaerobic microorganisms, in a fluid and counting those images. The method includes use of the captured image information to relate acquired microorganism information to anaerobic digestion process conditions. The information is further used in the method to adjust the digestion process as may be needed. This allows for an inexpensive means of confirming the bio-assay of an anaerobic sludge and the results of various performance strategies of anaerobic digestion, and may be correlated to a reliable methane output. After verification of the assay genetically, and images correlated to their genetic material, various biological experiments can be performed with exponential reductions in program and laboratory expenditures.

### FIELD OF THE INVENTION

The present invention relates generally to systems for analyzing fluids. More particularly, the present invention relates to systems and methods for modifying observing the contents of the fluid, including obtaining images of particles within the fluid. Still more particularly, the present invention relates to systems and methods for determining effectiveness of waste water treatment using microorganism particle imaging information.

### BACKGROUND OF THE INVENTION

Various optical/flow systems exist for analyzing the contents of fluids. Some provide for the imaging and optical analysis of the contents of a fluid, including the contents of a moving fluid. A liquid sample is typically delivered into the bore of a chamber and the sample is interrogated in some way so as to generate analytical information concerning the nature or properties of the sample. The sample may be stagnant or flowing. In one arrangement, a light source may be directed to the chamber to illuminate its contents. One or more photographs may be taken of the illuminated contents for the purpose of capturing one or more views of the contents of the fluid located in the photographic field. In another arrangement, a laser beam may excite the sample present in the chamber. Fluorescence energy emitted as a result of the excitation can provide signal information about the nature of the contents of the sample.

Obtaining images has been and remains a reasonable way to detect and observe the contents of samples, particularly fluid samples. Images of particles of all sorts may be captured and analyzed, dependent upon the quality of the imaging and me sophistication of analysis software used. Fluid Imaging Technologies, Inc., of Scarborough, Me., provides a product named FlowCAM®, which product may be used to detect and capture images of particles in a fluid. The product further provides a means for analyzing the captured images to identify the particles.

Anaerobic digestion is a collection of processes by which microorganisms break down biodegradable material in the absence of oxygen. The process is used for industrial or domestic purposes to manage waste and/or to produce fuels.

The digestion process begins with bacterial hydrolysis of the input materials and ends with the conversion of intermediate components into methane and carbon dioxide. Methanogenic archaea bacteria populations play an important role in anaerobic wastewater treatments.

Anaerobic digestion is used as part of the process to treat biodegradable waste and sewage sludge. As part of an integrated waste management system, anaerobic digestion reduces the emission of landfill gas into the atmosphere. Anaerobic digesters can also be fed with purpose-grown energy crops.

Anaerobic digestion is widely used as a source of renewable energy. The process produces a biogas, consisting of methane and carbon dioxide, and traces of other gases. The biogas can be used directly as fuel, in combined heat and power gas engines or upgraded to natural gas-quality biomethane. The nutrient-rich digestate also produced can be used as fertilizer.

For the bacteria in anaerobic digesters to access the energy potential of the biomaterial in the wastewater or in any other source of biomaterial, complex polymer chains of the biomaterial must first be broken down into smaller constituent parts. These constituent parts, or monomers, such as sugars, are readily available to other bacteria. The process of breaking these chains and dissolving the smaller molecules into solution is called hydrolysis. Therefore, hydrolysis of these high-molecular-weight polymeric components is the necessary first step in anaerobic digestion. Through hydrolysis, the complex organic molecules are broken down into simple sugars, amino acids and fatty acids.

Acetate and hydrogen produced in the first stages can be used directly by methanogens. Other molecules, such as volatile fatty acids (VFAs) with a chain length greater than that of acetate must first be reduced to compounds that can be directly used by methanogens. The biological process of acidogenesis results in further breakdown of the remaining components by acidogenic (fermentative) bacteria. The third stage of anaerobic digestion is acetogenesis. In this stage, simple molecules created through the acidogenesis phase are further digested by acetogens to produce largely acetic acid, as well as carbon dioxide and hydrogen.

The terminal stage of anaerobic digestion is the biological process of methanogenesis. Here, methanogens use the intermediate products of the preceding stages and convert them into methane, carbon dioxide, and water. These components make up the majority of the biogas emitted from the system. The remaining, indigestible material the microbes cannot use and any dead bacterial remains constitute the digestate.

Large-scale anaerobic digesters nave been in use for many years where it is desirable to convert waste rather than simply dispose of it. Municipal wastewater treatment plants use anaerobic digesters to treat wastewater. Anaerobic digesters can be simple or complex and can be operated in batch or continuous mode. It is preferable to operate in continuous mode when large treatment volumes exist. In any digester, it is desirable to maximize the digestion process efficiency in order to keep costs and maintenance as low as possible.

The biology of anaerobic digestion has been the subject of theory and hypothesis since the process was conceived. Years of discussion on the nature of the biology of anaerobic digestion have led to some pertinent microorganisms being classified as bacteria, although newer biological classifications have been defined, such as Archaea. Understanding the conditions and presence of this biology becomes increasingly relevant in fluid treatment and energy production applications. Some research has provided rough guidance on the sixes of many of these microorganisms but that information has not been sufficiently effective in the improvement of anaerobic digestion.

It would therefore be helpful to identify and characterize the methanogen bacteria and archaea that exist in a digester as a way to improve the selection and use of digestion materials, digestion temperatures, flow rates and digestion dwell times. Unfortunately, existing analysis methods are limited for the purpose of determining digestion efficiency. They focus on large-scale analysis of the fluid under treatment, output gases and digestate. That analysis occurs upon completion of the process rather than during the process such that modifications must occur with the next batch of fluid to be treated. Better analysis techniques are needed in the field of anaerobic digestion.

### SUMMARY OF THE INVENTION

The present invention is a system and related method to enable the analysis of the contents of a fluid, particularly a fluid containing methanogens. The invention provides an efficient and cost-effective way for detecting methanogens in a fluid, imaging these particles and determining their population density within a designated volume of the fluid. In turn, the effectiveness of an anaerobic digestion process can be determined based on that methanogen information. The digestion process may then be modified as needed to improve efficiency and thereby reduce cost and/or increase production.

It was theorized by the present inventors that one could filter an anaerobic sludge sample to a representative micron level and review images of methanogens in an applicable range of size. Once an image of a potential methanogen was identified, population densities of these microorganisms could be defined. This in turn could be used to determine digester performance criteria with the expectation of determining the characteristics that influence the densities of this biology and whether any correlation with methane production exists.

The system of the present invention includes a particle imaging system configured to detect, image and analyze particles in a fluid subject to anaerobic digestion treatment. The particle imaging system is coupled to a fluid transfer device, which may be a syringe containing fluid to be analyze. The fluid transfer device may also be a conduit configured to transport therein fluid diverted from a fluid treatment system. The particle imaging system receives the fluid sample, which may have been, but does not have to be diluted dependent on the clarity of particles contained in the sample. The particle imaging system includes a flow chamber configured to restrict the depth of field of the sample so that clear images may be captured. The particle imaging system includes lighting and photographic equipment described herein for the purpose of creating effective lighting and coordinated photograph taking. The FlowCam® fluid imaging system available from Fluid Imaging Technologies, Inc., of Scarborough, Me., is suitable for capturing images in the sample fluid.

The flow chamber includes a channel arranged to transport the sample fluid there through at a selectable rate. The particle imaging system also includes a backlighting generator arranged to illuminate the fluid in the flow chamber, an objective arranged to receive incident optical radiation from the flow chamber, a light source arranged to generate light scatter from particles in the fluid, one or more detectors to detect light scatter caused by the particles upon illumination, a signal processor configured to receive signals from the one or more detectors and an image capturing system including means to capture images of particles in the fluid. The backlighting generator may be a light emitting diode flash. The backlighting generator generates a high intensity flash. The system also includes a computing device to receive signals from the image capturing system. The computer device may be the same computer device used to control fluid transfer through the fluid dilution system. The image capturing system includes a digital camera or an analog camera and a frame grabber. The image capturing system also includes a CCD or a CMOS camera.

The present invention is also an apparatus to assist in the imaging of particles in a fluid, the apparatus has a flow chamber including a channel arranged to transport the fluid there through at a selectable rate, which may even be stagnant.

The present invention also provides a method for imaging particles in a fluid which is transported through a channel of a flow chamber at a selectable rate and illuminated with a light source so that scatter signals are detected. The method includes as primary steps the steps of acquiring one or more samples from a fluid subjected to anaerobic digestion, passing the sample through the flow chamber, capturing images of particles in the sample, gathering data regarding characteristics of the particles, such as organisms, in the pre-treatment sample(s), and analyzing the captured images for microorganisms associated with anaerobic digestion including, but not limited to, archaea and bacteria species. The method includes the optional step of running the same steps prior to treatment and then comparing the results of the microorganism analysis before and after treatment.

The present invention enables the imaging of microorganisms in a fluid and determining the effectiveness of anaerobic digestion treatment of the contents of the fluid based on the imaging information. These and other advantages of the present invention will become more readily apparent upon review of the following detailed description, the accompanying drawings, and the appended claims.

### BRIEF DESCRIPTION OF THE DRAWINGS

FIG. 1 is a front view of an example embodiment of the system of the present invention for imaging the contents of a fluid.

FIG. 2 is a perspective view of the system shown in FIG. 1.

FIG. 3 is a simplified schematic representation of the particle imaging system of the present invention.

FIG. 4 is a diagram of the flow cell in one embodiment of the particle imaging system of the invention.

FIG. 5 is a flow diagram representing primary steps of the method of particle image capturing and analysis of the present invention.

FIG. 6 is an image of an anaerobic microorganism imaged using the particle imaging system of the present invention in a study carried out using the method of the present invention.

FIG. 7 is a graph of a correlation between the number of anaerobic microorganism images counted in a specific sampling over time with changes in anaerobic digestion information when studied for a first digester.

FIG. 8 is a graph of a correlation between the number of anaerobic microorganism images counted in a specific sampling over time with changes in anaerobic digestion information when studied for a second digester.

FIG. 9 is a graph of a correlation between the number of anaerobic microorganism images counted in a specific sampling over time with changes in anaerobic digestion information when studied for a third digester.

### DETAILED DESCRIPTION OF THE PREFERRED EMBODIMENTS

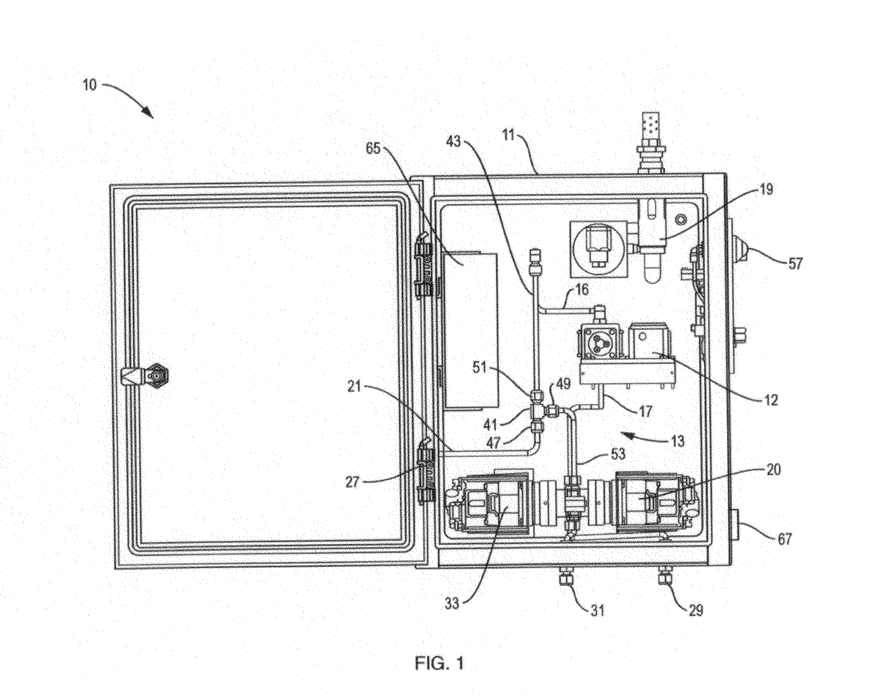

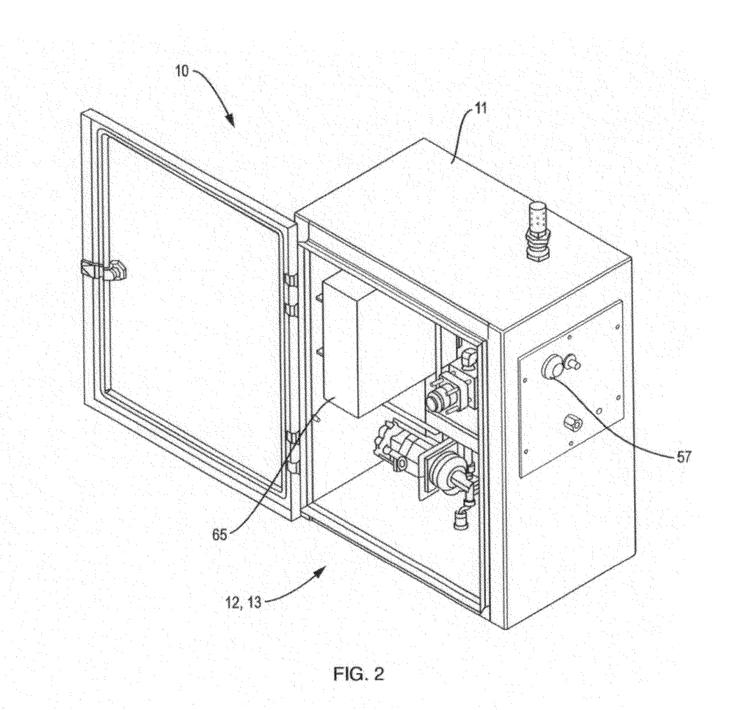

An example of a system 10 of the present invention suitable for the generation of high quality automated imaging of particles that exist in a fluid is shown in FIGS. 1 and 2. The system 10 includes an optional containment box 11, a particle imaging system 12, an optional cooling element 19 and a computing device 65. The containment box may be weather tight so that the system 10 may be deployed to a remote location for automated sampling, for example, wherein data are collected and either processed onsite and the results transmitted to a different location, or the data may be transmitted to a different location for processing. The computing device 65 forms part of the particle imaging system 12 and may be embodied in a single computing device as represented herein or as a plurality of computing devices, wherein the plural computing devices in that embodiment are in signal exchange communication with one another.

The particle imaging system 12 includes a sample inlet 31 and a sample pump 33. The sample inlet 31 may be coupled to a source (not shown) of a fluid to be evaluated for particle content. The sample source may be any sort of container arranged for retaining therein a sample fluid of interest. The container may be a syringe, for example, but not limited thereto. The fluid sample is transferred through operation of the sample pump 33, which draws the sample from the sample inlet 31.

The containment box 11 may include a purge port 57 for exhausting gases that may build up within the box 11 in the course of analyzing the sample. Such build up may occur as a result of operation of the components of the system and any cooling agent that may be exhausted by the cooler 19. The purge port 57 may be coupled with a Mimi-Z9Y purge unit available from Expo Technologies, Inc., of Twinsburg, Ohio, for example. The cooler 19 should be sufficiently robust to remain operable in harsh environments. A device that uses compressed air to produce a jet of cold air or a thermoelectric device can perform that function. The AVC-000-003 cabinet cooler available from Expo Technologies, Inc., of Twinsburg, Ohio, is suitable for that purpose. The sample pump 33 may be arranged, with stepper motors and controlled with stepper controllers managed by the computing device 65. The sample pomp 33 may be a Model STRH precision adjustment stepper miniature OEM pump available from Fluid Metering, Inc., of Syosset, N.Y. The conduits may be formed of any one or more of several nonmetallic materials including, but not limited to, polypropylene. Alternatively, one or more metallic materials may be used including, but not limited to, stainless steel, or any other material capable of transporting the fluids to be inspected.

The system 10 may include one or more sensors for sensing conditions inside and outside the containment box 11 and that information used in performing the steps described herein and may include one or more sensors for sensing temperature and/or pressure within and outside the containment box 11 as well as any location of interest associated with the particle imaging system 12 and the optional cooling element 19. One or more fluid position sensors, such as optical sensors, are used to sense fluid location in the conduits and that information transferred for use in controlling the functioning of the pump. The OCB350L250Z fluid position sensor torn OPTEK. Electronics of Carrollton, Tex., is a suitable optical sensor for that purpose.

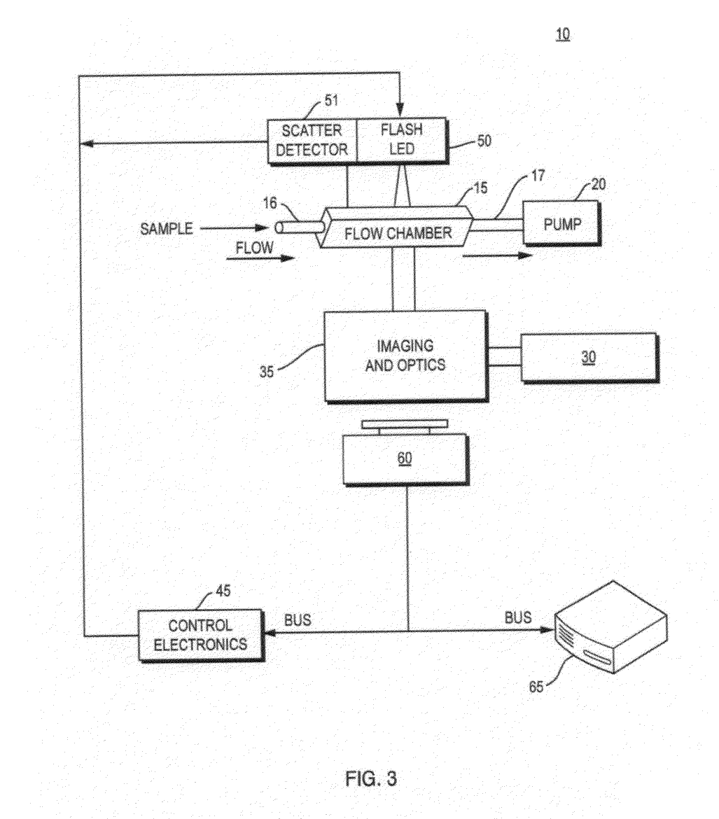

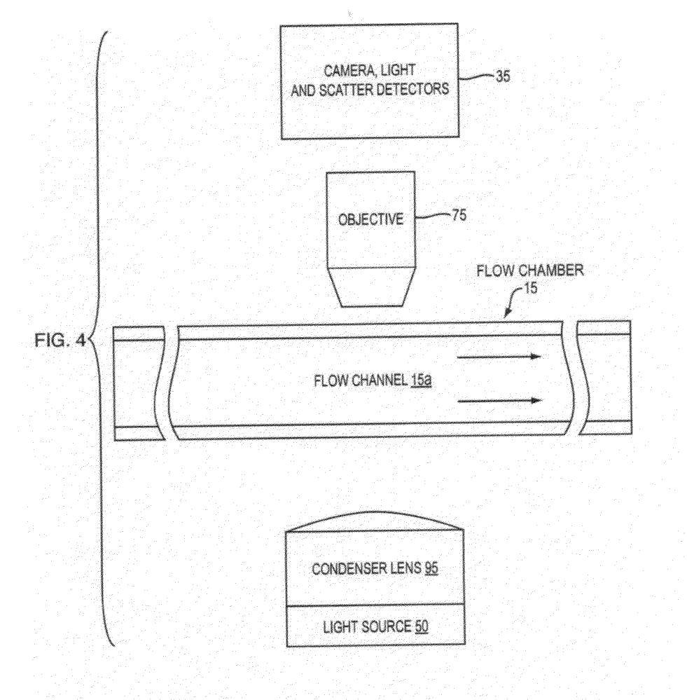

With reference to FIGS. 3 and 4, the particle imaging system 12 includes a flow chamber 15 coupled to inlet conduit 16 and outlet conduit 17, a light source 30, an imaging and optics system 35, an image detection system 40 including control electronics 45, a backlighting generator 50, an image capturing system 60 and the computing device 65. The combination of these components of the system 10 arranged and configured as described herein enable a user to detect particles in the sample and, specifically, to enhance the accuracy and sensitivity of such detection.

The flow chamber 15 includes an inlet for receiving the particle-containing sample to be evaluated and an outlet through which the sample passes out of the flow chamber after imaging functions have been performed. The flow chamber 15 may be fabricated of a material suitable for image capturing, including, for example, but not limited to, transparent microscope glass or glass extrusions that may be ruggedized to withstand abrasive materials. The flow chamber 15 may be formed in a rectangular shape as shown or it may be U-shaped. The flow chamber 15 may be circular or rectangular in shape. The flow chamber 15 defines a channel 15a through which the fluid flows at a predetermined selectable rate determined by operation of me diluent pump 20. The channel 15a may be of rectangular configuration. The length and width of channel 15a are selected to roughly match the field of view of the imaging optics 35 and may further be sized as a function of the particular fluid to be analyzed and the desire to avoid clogging. The particle imaging system 12 may include the use of multiple ones of the flow chamber 15, which may be substituted, used in series or used in parallel. The inlet of the flow chamber 15 is connectable to the inlet conduit 16 and the outlet is correctable to the outlet conduit 17.

The light source 30 is used to generate scatter excitation light which is passed through the optics and imaging system 35 to the flow chamber 15, resulting in light scatter by particles located in the fluid. The light source 30 may be a high-powered LED. The imaging and optics system 35 includes a microscope objective 75 to image the particle flow onto the image capturing system 60 and focus excitation light from the light source 30 onto the flow chamber 15. The control electronics 45 may be configured to receive input signals and produce output information compatible with the specific needs of the user of the system 10. An example of a suitable electronics system capable of performing the signal activation and output information associated with the control electronics 45 of the system 10 is the detection electronics described in U.S. Pat. No. 6,115,119, the entire content of which is incorporated herein by reference. Those of ordinary skill in the art will recognize that the specific electronics system described therein may be modified, such as through suitable programming for example, to trigger desired signal activation and/or to manipulate received signals for desired output information.

The light source 30 may be operated to transmit light periodically, sporadically, or regularly. For example, the light source may emit light signals and a scatter detector 51 may be employed on the back side of the flow chamber 15 to detect changes in light signals from the light source, such as when a particle passes through the flow chamber 15. The scatter detector 51 may be any type of suitable device capable of detecting variations in received light and transmitting electrical signals indicative of the light variations. In one embodiment, the scatter detector 51 may be an array of photoreceptive sensors. The scatter detector 51 is coupled to the control electronics 45 to signal to the control electronics the light change indicative of the existence of a particle in the flow chamber 15. The control electronics 45 is coupled to the computing device 65. The computing device 65 is programmed to store the information received from the control electronics 45 and to make calculations and processing decisions based on the information received. The computing device 65 may also be a data collector that transmits the collected data to a different computing component for processing at that component. The computing device 65 is also configured to transmit operational instructions to the pump 33 as well as other devices of the system 10.

The computing device 65 may be any sort of computing system suitable for receiving information, running software programs on its one or more processors, and producing output of information, including, but not limited to images and data, that may be observed on a user interface. The computing device 65 may be embodied in one device, as shown in FIGS. 1 and 2; it may comprise a plurality of components that are connected by wire or wirelessly to one another. The computing device 65 may also gather data and transmit that data from a remote location to a location that processes the data. The computing device 65 may be managed remotely or locally. For example, the computing device 65 may be configured with a transmission/reception capability, such as through wireless signal exchanges established at wireless transceiver interface 67 shown in FIG. 1, for data and device management signal exchanges. The signal exchange arrangement may be used to schedule the undertaking of sample fluid analyses. It may also be used to incorporate the system 10 into a bigger processing system.

The control electronics 45 is also coupled, directly or indirectly through the computing device 65 to the backlighting generator 50, which may include a condenser lens 95. In particular, the control electronics 45 and the computing device 65 are arranged to generate a trigger signal to activate the backlighting generator 50 to emit a light flash upon detection of a particle or particles in the flow chamber 15. That is, the trigger signal generated produces a signal to activate the operation of the backlighting generator 50 so that a light flash is generated. Specifically, the backlighting generator 50 may be a Light Emitting Diode (LED) flash or other suitable light generating means that produces a light of sufficient intensity to backlight the flow chamber 15 and image the passing particles. The LED flash may be a 670 nm LED flash, or a flash of another other suitable wavelength of high intensity, which is flashed on one side of the flow chamber 15 for 200 μsec (or less). At the same time, the image capturing system 60 positioned on the opposing side of the flow chamber 15 is activated to capture an instantaneous image of the particles in the fluid suspended in a fixed position when the strobe effect of the high intensity flash occurs. One or more mirrors may be employed to divert light if it is determined that the backlighting is too intensive for effective image capture. The high NA condenser lens 95 aids in clear illumination of that section of the fluid in the flow channel 15a that is to be imaged by focusing the high intensity flash from the backlighting generator 50 to that section. The high NA condenser lens 95 includes characteristics of a numerical aperture of about 1.25 and may be the AA2354932 1.25NA Abbe condenser available from Motic Incorporation Ltd. of Hong Kong.

The image capturing system 60 is arranged to either retain the captured image, transfer it to the computing device 65, or a combination of the two. The image capturing system 60 includes characteristics of a digital camera or an analog camera with a frame grabber or other means for retaining images. For example, but in no way limiting what this particular component of the system may be the image capturing system 60 may be, but is not limited to being, a CCD firewire, a CCD USB-based camera, or other suitable device that can be used to capture images and that further preferably includes computing means or means that may be coupled to computing means for the purpose of retaining images and to manipulate those images as desired. The computing device 65 may be programmed to measure the size and shape of the particle captured by the image capturing system 60 and/or store the data for later analysis.

The images captured by the image capturing system 60 and stored with the computing device 65 may be analyzed and compared to known images of particles including, for example, rod species of Archaea. When a trigger is generated (i.e., a light scattering particle is detected), software scans the resulting image, separating the different particle sub-images in it. The area of each particle may be measured by summing the number of pixels in each particle image below a selectable threshold and multiplying the result by the equivalent physical area of a pixel. This computed area of the particle is stored in a spreadsheet-compatible file along with other properties of the particle, e.g., time of particle passage and the location of the particle in the image. The sub-image of each particle is copied from the chamber image and saved with other sub-images in a collage file. Several of these collage files may be generated for each system experiment. A special system file is generated, containing the collage file location of each particle sub-image, particle size and time of particle passage.

The software is written to generate two data review modes: (1) image collage and (2) interactive scattergram. In the image collage mode, the user may review a series of selectable sub-images in a collage file. Reviewing these files allows the user to identify particle types, count particles, or study other features. In interactive scattergram mode, data are presented to the user as a dot-plot; e.g., a graph of particle size. If the user selects a region of the scattergram, images of particles having the characteristics plotted in that region are displayed on a display of the computing device 65, allowing the user to study panicle populations and to examine images of particles with specific sizes, such as cells of a specific type. Because a spreadsheet compatible file is generated for each review, the user may also review the data with a spreadsheet program. This information allows the user to readily generate cell counts and scatter and size distribution histograms for each sample. This file also contains the location of each particle in the original image which is used to remove redundant data from particles that have become attached to the flow chamber 15.

The system 10 further optionally includes one or more additional pumps that transport a plurality of sample fluids and/or diluents dependent on the existence of sample fluid sources and/or a desired diluent to use. The multiple inputs may be manifolded and fluid and diluent selection may be made through controls established through the computing device 65.

As represented in FIG. 5, a method 200 of the present invention embodied in one or more computer programs, includes steps associated with storing and analyzing images captured with the system 10 of the present invention. In the first step, step 202, the light source 30 and imaging optics 35 generate scatter excitation light which is directed to the flow chamber 15 within which a fluid to be monitored passes, step 204. The particle imaging system 12 including the control electronics 45 is used to detect separately, images associated with the light waveforms scattered from particles in the flow chamber 15. The detected images are transferred to the computing device 65 for storage and analysis, step 206. The images captured are characterized based on particle shape and size, in addition to other information of interest, step 208. Features representative of the particles in the fluid may be detected and that information may be reported in a visual manner, step 210. The visual manner may be photographic images, spreadsheets, other displays or any combination thereof. The images are characterized by size, shape and population density.

With continuing reference to FIG. 5, the acquired image information is used to compare captured images with library images of known microorganisms of particular interest in the process of anaerobic digestion, step 212. If determined to be representative of such microorganisms, the captured particles are counted and reported, step 214. The acquired information is then correlated to conditions associated with the anaerobic digestion process, step 216. That correlation information may then be used to adjust one or more features of the anaerobic digestion process including, but not limited to, changing the fluid input characteristics, changing the temperature of the reaction process, changing the fluid dwell time in the reaction process and changing one or more microorganisms used in the process, step 218. Optionally, the steps may be repeated until such time as satisfactory efficiency conditions are realized, step 220.

### EXAMPLE OF USE OF THE SYSTEM AND METHOD

A two-month study was conducted to determine the effectiveness of characterizing microorganisms in a fluid using the FlowCAM® device as the system 10 in the analysis of sewage treatment using anaerobic digestion. Three anaerobic digesters with independent feeds (or “trains”) were used to carry out the method of the invention, The digestion trains followed a Modified Ludzack-Ettinger (MLE) activated sludge process with traditional primary clarification feeding two of the trains, and a secondary waste stream with a thickening component feeding a third. For the duration of the two-month study there were no blending of the feeds, which was the normal configuration of the digester feed characteristics, but did not constitute a change in digester operation. Data conventional to normal digester process management continued to be sampled. These data included TSS/VSS and pH of feed sludge, digester temperatures and CO₂ levels, all measured with conventional methods. For purposes of understanding the results in relation to the present invention, TSS represents Total Suspended Solids. It is a measure of total, particulates in a fluid sample. It is determined by pouring a carefully measured volume of water through a pre-weighed filter of a specified pore size, then weighing the filter again after drying to remove all water. The gain in weight is a dry weight measure of the particulates present in the water sample expressed in units derived or calculated from the volume of water filtered (typically milligrams per liter or mg/l), VSS represents Volatile Suspended Solids. It is determined by taking a TSS sample and heating the sample to 550 C. What is left on the filter after heating is essentially just inorganic matter. The difference in the weight of the filter before and after heating is a determination of organic matter in the sample. That is, it is an indication of the bacterial population of the sample. In untreated sanitary waste it is a measure of the human waste. The pH measurement is a determination of hydrogen ion concentration of the sample and indicates if the sample is acidic or alkaline. Generally, the pH most be maintained between 6.5 and 7.5 to promote methane gas formation. Decreases in pH mean possible digester upset.

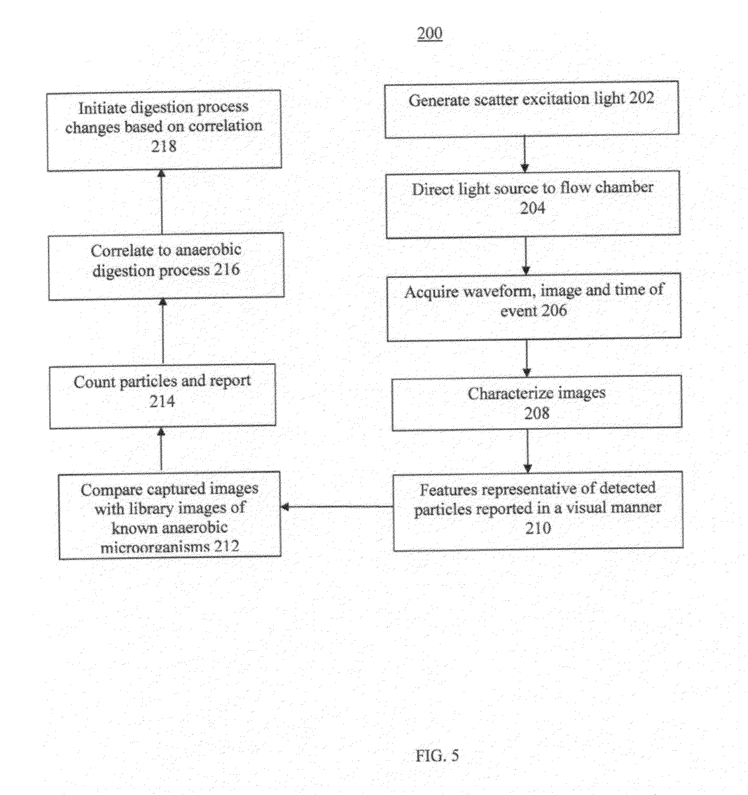

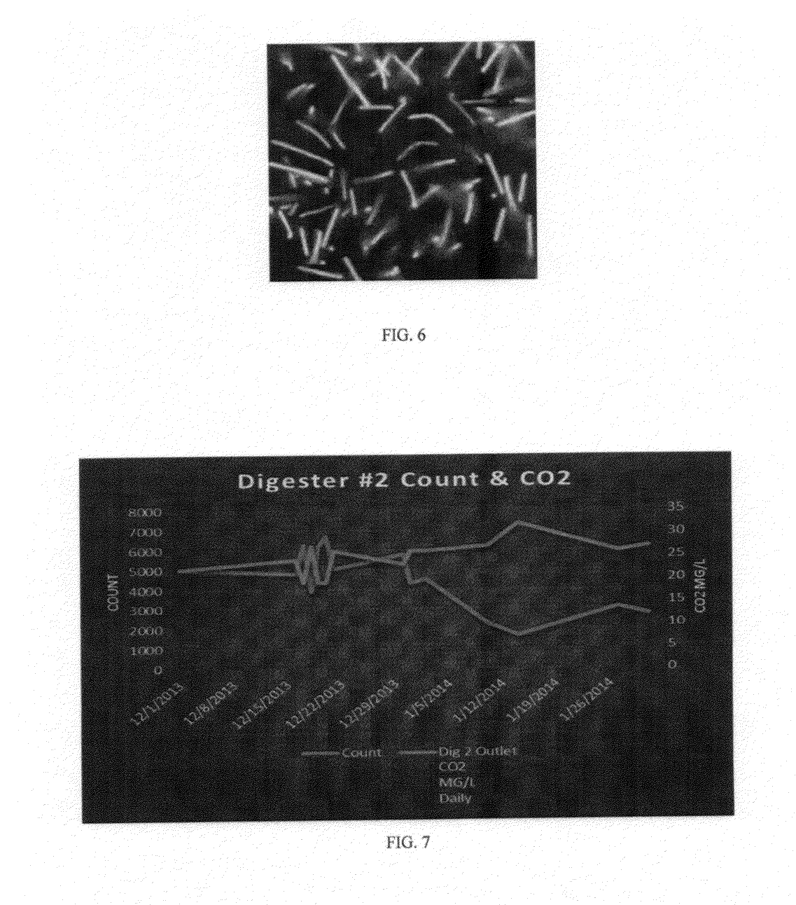

All three digesters were mixed continuously during the sampling period utilizing jet mixing driven by Vaughn Chopper pumps. Samples were taken from each digester and analyzed with the FlowCAM® imaging particle analyzer ahead of the study to identify potential methanogen shapes as documented through previous scientific studies. Preliminary samples were filtered to 10 microns in keeping with known particle sizes of rod-shaped Archaea believed to be methane forming organisms. With relative ease, the shapes were identified and classified using FlowCAM software. An image filter was created to analyze the densities of these shapes in future samples. FIG. 6 shows the particle images for Archaea detected in the fluid samples taken.

Sample frequencies of the conventional digester performance data were taken at intervals consistent with normal process control procedures. In this case, once per day, although they can also be taken and measured more frequently. Sample frequencies analyzed using the on-line FlowCAM® imaging particle analyzer available from Fluid Imaging Technologies of Scarborough, Me., were taken Monday through Friday for the duration of the two-month study. Data were compiled and analyzed at the end of the two-month period to determine if there were any correlations in the population densities of the shapes identified and conventional digester performance criteria, it is to be understood that other particle imaging and analysis devices can be used for the same purposes, provided they are at least as qualitatively effective. Other FlowCAM® devices that would be suitable include the VS, PV and portable versions of FlowCAM®.

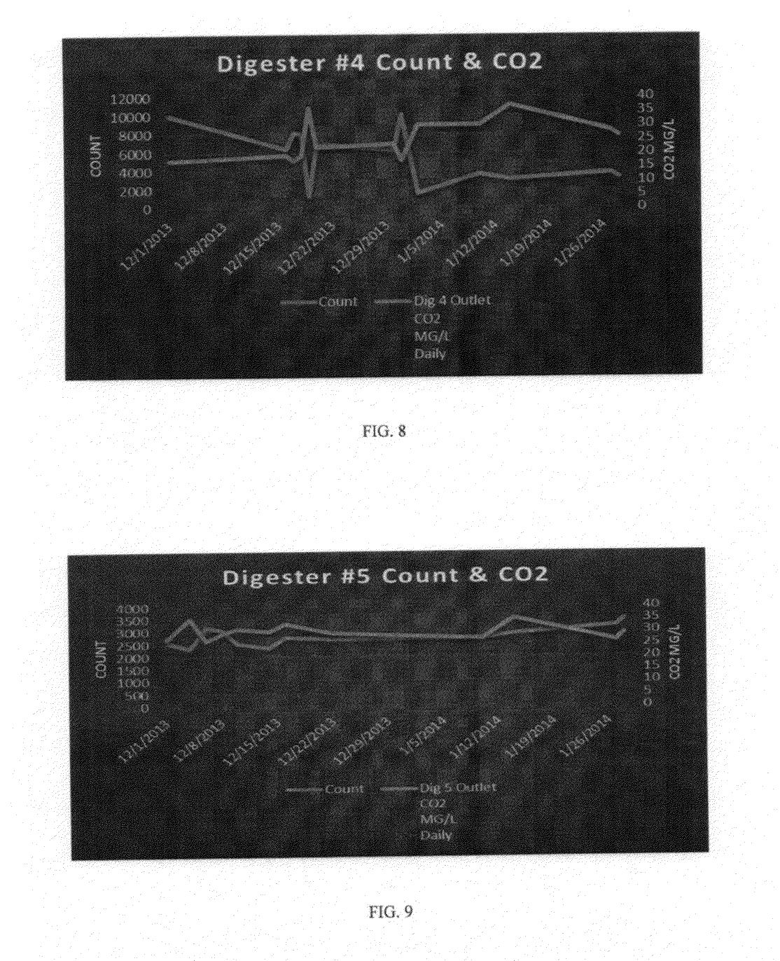

There were no specific Archaea identified in the study. Instead, the study made assumptions that the bacilli shapes identified in images that had been captured from each digestion train and filtered to ten microns or less were some form of methanogen. After reviewing the image density of the samples and comparing that trend to normally sampled process trends, it was determined that the densities of these shapes in the digester samples do correlate to performance trends sampled during the two-month time frame. Increases in volatile solids reductions correlated to increases in image densities and decreases in CO₂ levels. CH₄ was not sampled as part of the study, so the assumption was made that the decrease in CO₂ was indicative of an increase in CH₄ levels. The correlations were surprisingly acute as it pertained to CO₂ levels. That is, the results of the microorganism analysis performed using the FlowCAM® product were surprising in the correlation between that information and volatile solids reductions carried out using the treatment process disclosed. The trend graphs shown in FIGS. 7-9 demonstrate these findings and lead to the conclusion that the FlowCAM® can be used much more effectively than conventional analysis methods to determine anaerobic digestion efficiencies, it was a surprising and unexpected result to obtain such a correlation. Typically, the gas produced is usually about 70 percent CH₄ and about 30 percent CO₂. An increasing percentage of CO₂ may be an indication that the digestion process is not proceeding properly. The disclosed findings show that with increasing “imaged methanogen” populations, the CO₂ levels decrease and therefore the CH₄ levels increase, and with decreasing populations, the CO₂ levels increase, reducing the amount of CH₄ generated.

The images representing actual methanogens were captured by the FlowCAM® device with great relative speed and accuracy. This allows for an inexpensive means of confirming the bio-assay of an anaerobic sludge and the results of various performance strategies of anaerobic digestion, and may be correlated to a reliable methane output. After verification of the assay genetically, and images correlated to their genetic material, various biological experiments could be performed with exponential reductions in program and laboratory expenditures.

As noted, it is to be understood that the computing device 65 used to gather the captured image information and to perform calculations and observe features of the captured image information may be associated with local or remote computing means, such as one or more central computers, in a local area network, a metropolitan area network, a wide area network, or through intranet and internet connections. The computing device 65 may include one or more discrete computer processor devices. The computing device may include computer devices operated by a centralized administrative entity or by a plurality of users located at one or more locations.

The computing device 65 may be programmed to include one or more of the functions of the system 10. The computing device 65 may include one or more databases including information related to the use of the system 10. For example, such a database may include known images of example particles of interest. The database may be populated and updated with information provided by the user and others.

The steps of the method 200 described herein and additional steps not specifically described with respect to FIG. 5 but related to fee use of the system 10 may be carried out as electronic functions performed through the computing device 65 based on computer programming steps. The functions configured to perform the steps described herein may be implemented in hardware and/or software. For example, particular software, firmware, or microcode functions executing on the computing device 65 can provide the trigger, image capturing and image analysis functions. Alternatively, or in addition, hardware modules, such as programmable arrays, can be used in the devices to provide some or all of those functions, provided they are programmed to perform the steps described.

The steps of the method 200 of the present invention, individually or in combination, may be implemented as a computer program product tangibly as computer-readable signals on a computer-readable medium, for example, a non-volatile recording medium, an integrated circuit memory element, or a combination thereof. Such computer program product may include computer-readable signals tangibly embodied on the computer-readable medium, where such signals define instructions, for example, as part of one or more programs that, as a result of being executed by a computer, instruct the computer to perform one or more processes or acts described herein, and/or various examples, variations and combinations thereof. Such instructions may be written in any of a plurality of programming languages, for example, C++ or any of a variety of combinations thereof. The computer-readable medium on which such instructions are stored may reside on one or more of the components of system 10 described above and may be distributed across one or more such components. Further, the steps of the method represented in FIG. 5 may be performed in alternative orders, in parallel and serially without deviating from the invention.

The system 10 of the present invention allows much greater flexibility in carrying out analyses of fluids. The system 10 may be used to identify particles in a highly viscous fluid, in a fluid with a significant solids content or a combination of the two. For example and not limited thereto, the system 10 may be used to identify particles in sewage sludge, which has a high solids content and is often too opaque to acquire any information about individual particles therein. In that situation, a fluid dilution system may be activated to dilute a sewage sludge sample to such a level that individual particles may be identified and characterized, such as by number, in a given volume of fluid. The capability of the system is not limited thereto.

One or more embodiments of the invention have been described. Nevertheless, it will be understood that various modifications may be made without departing from the spirit and scope of the invention as described by the following claims. All equivalents are deemed to be within the scope of the claims.

1. A method for determining anaerobic digestion effectiveness in a fluid treatment system, the method comprising the steps of:
a. directing a portion of the fluid to a particle imaging system, the particle imaging system including:
i. a flow chamber arranged to transport the fluid portion there through;
ii. a light source arranged to generate scatter excitation light to illuminate particles in the fluid in the flow chamber;
iii. a backlighting generator arranged to produce a light of sufficient intensity to backlight the flow chamber;
iv. a microscope objective arranged to focus light from the light source onto the flow chamber;
v. a scatter detector to detect changes in the light from the light source indicative of the existence of one or more particles in the flow chamber;
vi. control electronics configured to receive signals from the scatter detector, wherein the control electronics are coupled to the backlighting generator and configured to activate the operation of the backlighting generator;
vii. an image capturing system including means to capture images of particles in the fluid; and
viii. a computing device to receive signals from the control electronics and the image capturing system;
b. identifying one or more microorganisms associated with the anaerobic digestion captured by the image capturing system;
c. counting the identified one or more microorganisms using the computing device;
d. correlating the counted identified one or more microorganisms with one or more features of the anaerobic digestion process; and
e. initiating one or more changes to the anaerobic digestion process based on the correlation.

2. The method of claim 1 further comprising the step of repeating steps a-e.

3. The method as claimed in claim 1 wherein the step of identifying includes the step of comparing images captured with the image capturing system to images in a library of known microorganism images.
